(19) United States
(12) Patent Application Publication
(10) Pub. No.: US 2008/0055177 A1
(43) Pub. Date: Mar. 6, 2008

(54) COMBINED SOLAR PANEL AND ANTENNA

(76) Inventor: Glenn B. Dixon, West Point, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/847,204

(22) Filed: Aug. 29, 2007

Related U.S. Application Data
(60) Provisional application No. 60/841,434, filed on Aug. 31, 2006.

(51) Int. Cl. H01Q 9/04; H01Q 1/00; H01Q 1/38

(52) U.S. Cl. 343/787; 343/700 MS

(57) ABSTRACT

A solar panel may be modified to function both as a solar panel and as a patch antenna. The use of combination solar cell and patch antenna allows for a greater amount of the upper surface of a device to be covered with solar panels, and may reduce the size and cost of the device. The ground layer of a printed circuit board in the device may be used as the ground plane of the patch antenna, further reducing the size and cost of the device.

### RELATED APPLICATIONS

The present application claims the benefit of U.S. Provisional Application Ser. No. 60/841,434, filed Aug. 31, 2006, which is expressly incorporated herein by reference in its entirety.

### BACKGROUND OF THE INVENTION

1. The Field of the Invention

The present invention relates to an improved antenna. More specifically, the present invention relates to an improved patch antenna which is integrated with a solar cell so as to provide both a solar cell and a patch antenna in a smaller space than would be occupied by both components separately.

2. State of the Art

An increasingly large number of electronic devices are now portable. Many advances allow for portable devices, including smaller and lighter electronics, electronics which use less power, improved batteries and power supplies, etc. These technological advances allow many types of electronic devices to operate without requiring wired connection to communications networks or power grids.

By way of example, monitoring and control devices are able to monitor desired conditions, such as shipping conditions for a sensitive or valuable object, control the shipping conditions, transmit data regarding the shipment to a remotely located control facility, and can even track the location of the shipment using GPS (Global Positioning Satellite) technology. It is often advantageous that such a device be capable of operating without an outside source of power and capable of communicating with outside facilities and devices.

It is desirable that such a device may operate without connection to an outside power source for extended periods of time. A solar cell is desirable for facilitating operation without an outside source of power. Batteries are often utilized, but the batteries capable of operating the device for extended periods of time (such as weeks or months) are typically much too large to be conveniently included in the device. Thus, solar panels are often used to power devices. Solar panels are often used in combination with batteries to provide energy to the device and to charge the batteries during the day and thereby extend the time period for which the device may operate. If the solar panel is large enough, the device may operate indefinitely. It is thus often desirable to have a solar panel which is large enough to meet the energy requirements of the device.

Solar panels have a relatively low power output, which often means using as large of a solar panel as is possible to provide as much energy as possible. Solar panels provide the most energy when the panel faces upwardly and has a clear view of the entire sky, allowing light to be collected during as long of a time period as is possible. Thus, it is often desirable to cover most, if not all, of the upper surface of a device with a solar panel to provide as much power as is possible from the solar panel.

It is also desirable to track the location of the device, and to communicate wirelessly with the device, such as through satellites. For example, GPS receivers allow for determination of the location of the device and thus allow for improved tracking and monitoring of the device. GPS systems require an antenna to communicate with the GPS satellites. A commonly used type of antenna is a patch antenna. A patch antenna is a flat rectangular antenna including an upper layer and a lower layer. Patch antennas for a GPS typically operate at a frequency of about 1.5 GHz. For best performance, the patch antenna should have a clear view of entire sky.

For many devices, it is desirable to have both a solar panel and a patch antenna. The patch antenna may not be simply placed underneath a solar panel since the solar panel is made of conductive materials and shields radio frequencies. Thus, the solar panel and patch antenna compete for space on the top surface of the device. Inclusion of a patch antenna typically means the solar panel must be reduced in size, or the device must be made larger. Both of these alternatives are often undesirable as they would either reduce the available power or increase the bulk and cost of the device.

There is thus a need for a patch antenna which overcomes the limitations of available antennas. Specifically, there is a need for a patch antenna which may be used in combination with a solar panel while allowing the solar panel to cover the entire usable top surface of a device so as to maximize the power available from the solar panel.

### SUMMARY OF THE INVENTION

It is an object of the present invention to provide an improved patch antenna.

According to one aspect of the invention, a combination solar panel and patch antenna is provided. The combined solar panel and patch antenna may utilize the lower layers of a solar panel to form the upper layer of a patch antenna. Such a combination allows for a solar panel which is as large as possible, and which does not interfere with operation of the patch antenna.

According to another aspect of the invention, the ground layer of a printed circuit board placed under the solar panel may form the ground plane of the patch antenna. Such a configuration eliminates the need for a separate ground layer for the patch antenna.

These and other aspects of the present invention are realized in a combined solar panel and patch antenna as shown and described in the following figures and related description.

### BRIEF DESCRIPTION OF THE DRAWINGS

Various embodiments of the present invention are shown and described in reference to the numbered drawings wherein:

FIG. 1 shows a top view of a patch antenna of the prior art;

FIG. 2 shows a side view of a portion of a patch antenna of the prior art;

FIG. 3 shows a side view of a portion of a patch antenna of the prior art;

FIG. 4 shows a side view of a solar panel of the prior art;

FIG. 5 shows a bottom view of a solar panel;

FIG. 6 shows a bottom view of a solar panel used in accordance with the present invention;

FIG. 7 shows a side view of a portion of a patch antenna of the present invention;

FIG. 8 shows a top view of a portion of a patch antenna of the present invention; and

FIG. 9 shows a side view of a patch antenna of the present invention.

It will be appreciated that the drawings are illustrative and not limiting of the scope of the invention which is defined by the appended claims. The various embodiments shown accomplish various aspects and objects of the invention. It is appreciated that not all aspects of the invention may be clearly shown in a single figure. Thus, multiple figures may be used to illustrate the various aspects of a single embodiment of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

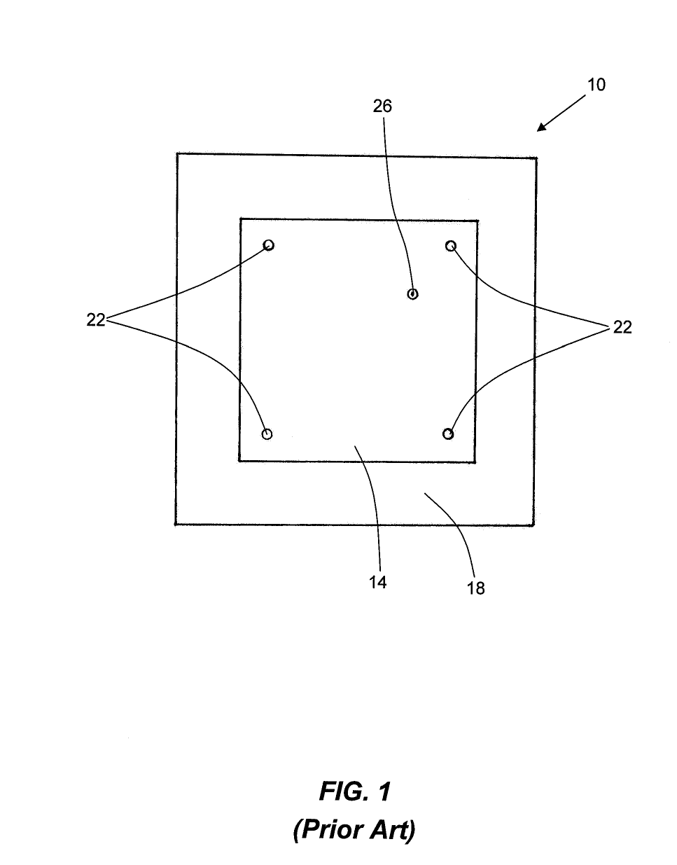

Turning now to FIG. 1, a top view of a patch antenna 10 of the prior art is shown. A patch antenna 10 includes conductive active element 14 which is rectangular in shape. The active element 14 is spaced above and parallel to another rectangular conductive ground plane 18. Standoffs 22 are often used to separate the active element 14 and the ground plane 18, using the air between the active element and the ground plane as the dielectric. Alternatively, another dielectric material may be used between the active element 14 and the ground plane 18. A signal line is attached to the signal feed point 26 and a ground line is attached to the ground plane 18, and a signal is developed between the signal line and the ground line.

The dimensions of the active element 14 and ground plane 18, the spacing and dielectric material, if any other than air is used, between the active element and ground plane, location of the feed point 26, feed line impedence, etc. all determine the operating parameters of the antenna 10. It is desirable to receive signals from all directions above the patch antenna 10. Design of ordinary patch antennas is understood in the art. For a GPS receiver operating at about 1.5 GHz, a ground plane 18 measuring 124 mm wide by 133 mm long and an active element 14 measuring 83.5 mm wide by 92.4 mm long which has a feed point located 23.5 mm in from the width edge and 29.8 mm in from the length edge, and attached to the ground plane at the corners by standoffs 22 located 7 mm in from the edges with a spacing of 5 mm between the active element and ground plane may optimum dimensions. Different frequencies, different dielectric materials, etc. will typically change the dimensions and design parameters.

An air dielectric typically results in the broadest overhead reception, but also results in the largest antenna. Thus, the antenna providing the best reception to a GPS receiver is also the largest antenna, resulting in the greatest reduction of the amount of space remaining for a solar panel. The reduction in size of the solar panel reduces the power output of the panel, requiring the device to carry additional batteries or reducing the time frame during which the device may function without connection to a power source.

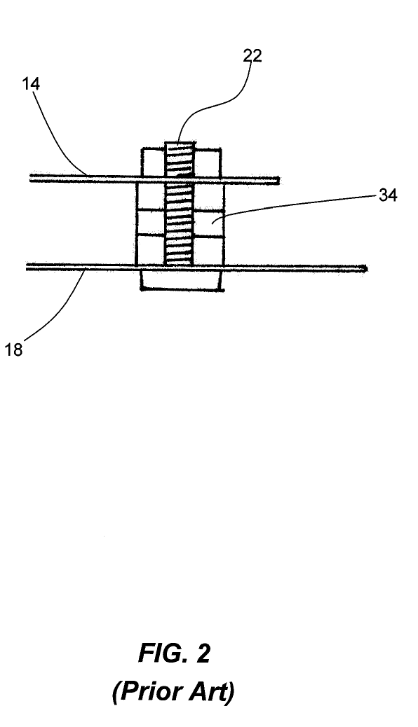

Turning now to FIG. 2, a side view of a portion of the prior art patch antenna of FIG. 1 is shown. It can more clearly be seen how the standoff 22 is used to create a space between the active element 14 and the ground plane 18. For the dimensions discussed above, the spacing is typically about 5 mm. The standoff 22 should electrically isolate the active element 14 from the ground plane 18. As such, a small nylon bolt may be used for the standoff, with plastic washers or spacers 34 used to maintain the desired spacing. Many other materials are suitable for use as standoffs.

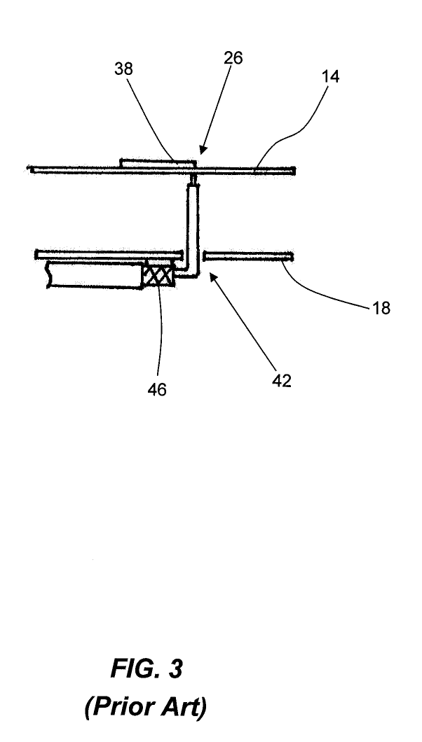

Turning now to FIG. 3, a side view of the feed point 26 of the prior art patch antenna of FIG. 1 is shown. The feed point 26 on the active element 14 is soldered to a wire 38, typically the center conductor of a shielded antenna wire. The wire 38 often passes through a hole 42 in the ground plane 18. The ground shield 46 of the antenna wire is connected to the ground plane 18.

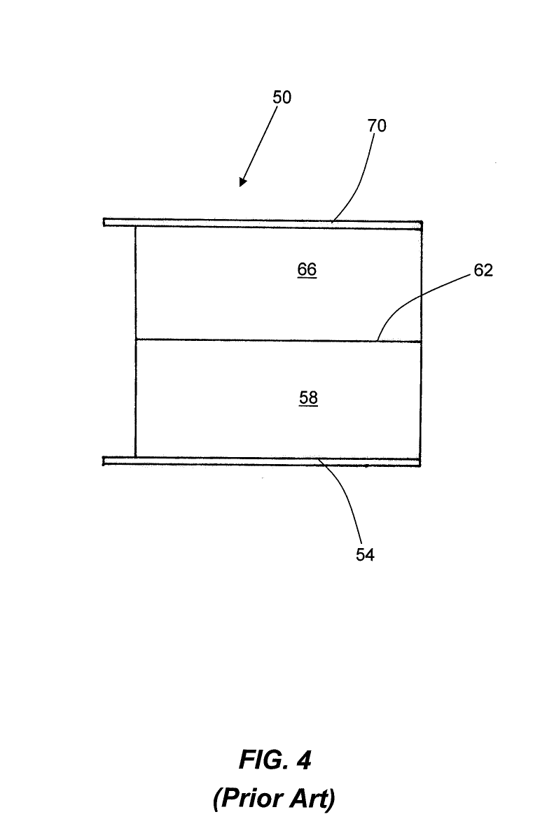

Turning now to FIG. 4, a side view of a solar panel 50 of the prior art is shown. The solar panel includes a conductive lower layer 54 which forms the positive terminal, a p-type semiconductor layer 58, a junction 62, an n-type semiconductor layer 66, and a transparent conductive layer 70 forming the negative terminal. Often, solar panels include several discrete sections of solar cells connected in series to thereby increase the voltage of the solar panel.

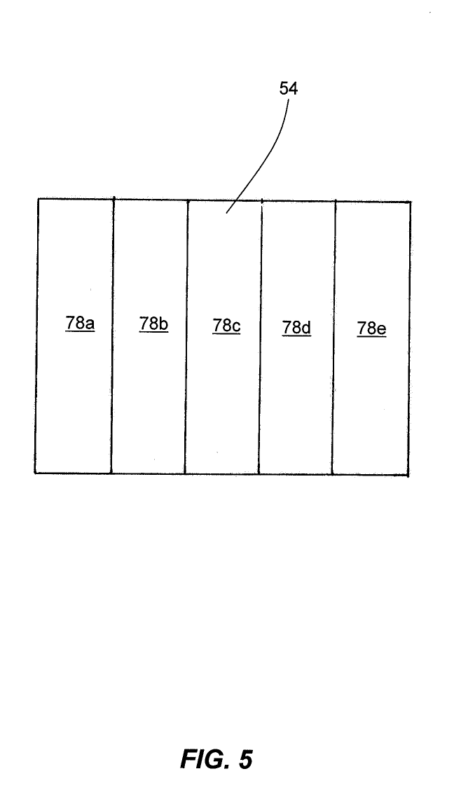

Turning now to FIG. 5, a bottom view of a solar panel is shown. According to the present invention, the conductive lower layer 54 of the solar panel may be used as the active element of a patch antenna. The lower layer 54 is shown as including multiple sections 78a-78e. The individual sections 78a-78e result from having five separate sections of solar cells connected in series to form the solar panel.

The lower layer 54 may be used to directly form an active element of a patch antenna if the conductivity of the lower layer is sufficiently good at the desired operating frequency and if the insulating barrier between any series connected plates has sufficient capacitance. If needed, a thin copper sheet or other conductive sheet may be attached to or placed directly underneath the solar panel. Such a conductive sheet may be used to improve the effectiveness of the antenna.

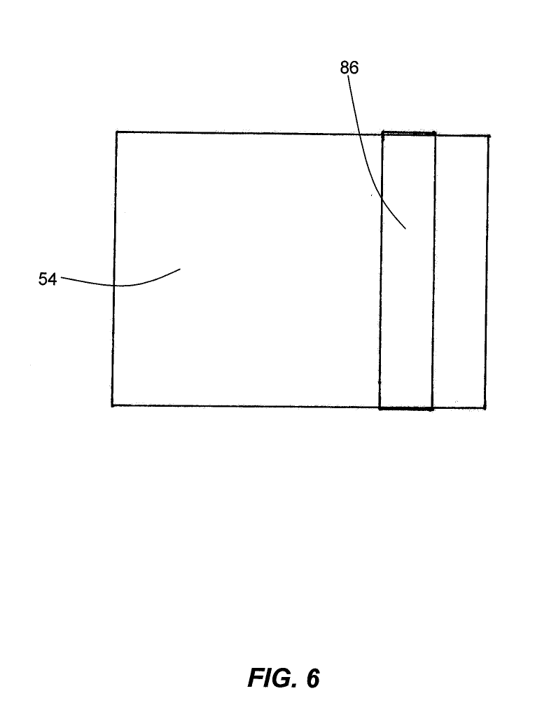

Turning now to FIG. 6, a bottom view of a solar panel used as an active element is shown. It will be appreciated that the lower layer 54 of the solar panel is often not the optimum size for a patch antenna. Several solutions to this problems may be used. A custom solar panel which is the desired active element size may be used. Alternatively, a ferrite bar 86 may be clamped or glued to the back of the solar panel to reduce the size of the portion of the solar panel lower layer 54 which will effectively receive the RF signals. It is understood that the ferrite bar shown here may be used with any of the embodiments of the present invention. Additionally, the available size of solar panel may be used, allowing the lower layer 54 to function as the active element by optimizing the remaining design parameters to the size of the lower layer used as the active element. Such may include changing the real and imaginary feed point impedence, location of the feed point, spacing to the ground plane, dielectric material, etc.

Antenna modeling programs, such as NEC2 (distributed at http://www.nec2.org), may be used to calculate what the feed line impedance should be for a given active element dimension, feed point location, and ground plane spacing.

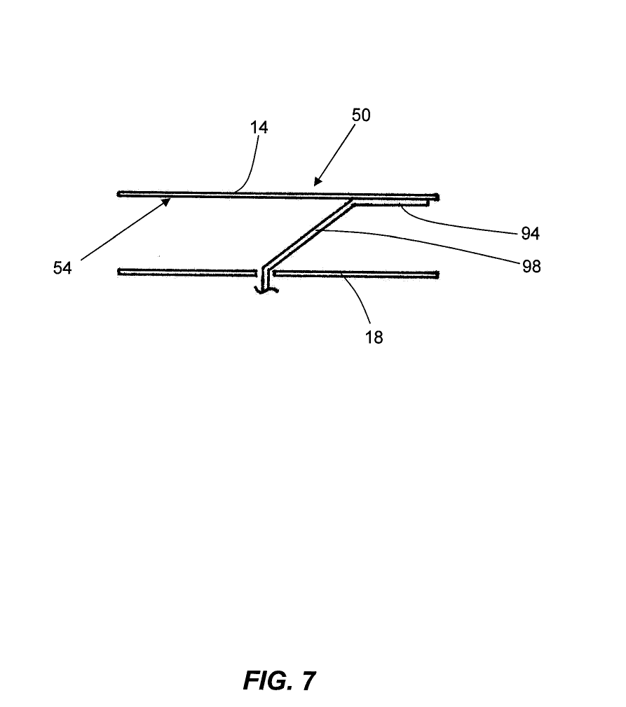

Turning now to FIG. 7, a side view of a portion of a patch antenna of the present invention is shown. In a typical patch antenna, the feed line is soldered to the active element in the desired location. In using a solar panel 50 for the active element 14, soldering may not always work as an attachment method. Many solar panels 50 use thin lower layers 54 which are covered by thin insulating layers. It can be difficult to remove the insulating layer and solder or otherwise connect the feed line to the lower layer 54 without damaging the lower layer.

The feed line can be capacitively connected to the lower layer 54 by placing a small capacitive plate 94 adjacent the lower layer 54. The capacitive plate 94 need not be soldered or directly connected to the conductive lower layer 54, as the insulating layer on the lower layer 54 is typically thin enough that the signals are effectively transferred to the capacitive plate 94. The capacitive plate 94 is typically attached to a spring arm 98, spring, or other means which presses the capacitive plate against the lower layer 54, and which is then connected to the signal wire.

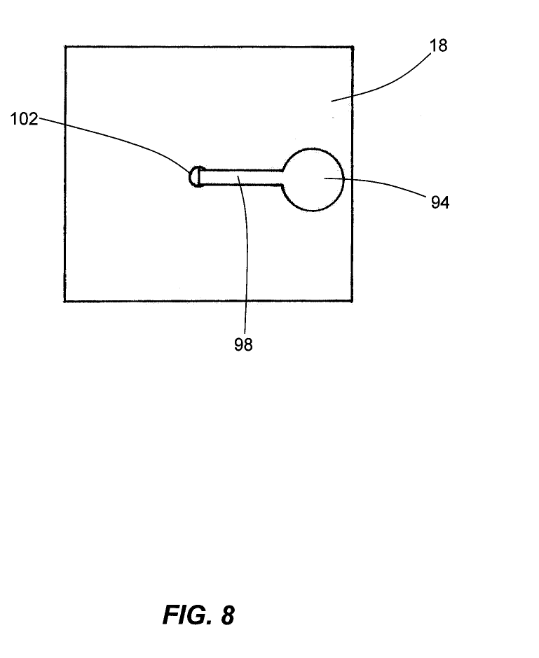

Turning now to FIG. 8, a top view of a portion of the ground plane and the capacitive plate of FIG. 7 is shown. The capacitive plate 94 is shown as round, but other shapes may work equally well. The spring arm 98 is typically made relatively short so as to provide good contact between the lower layer 54 and the capacitive plate 94. As such, the spring arm 98 often passes through a hole 102 in the ground plane 18, and is insulated sufficiently to be electrically isolated from the ground plane.

Alternative arrangements exist which are equally effective in connecting a signal wire to the lower layer 54. The signal wire may be soldered to the lower layer 54 if the lower layer permits soldering thereto. Alternatively, a small spring or post may be placed below the feed point such that the spring or post is placed in electrical communication with the lower layer 54. A spring or post with a capacitive plate 98 may be used, or the spring or post may directly contact the lower layer and not need a capacitive plate.

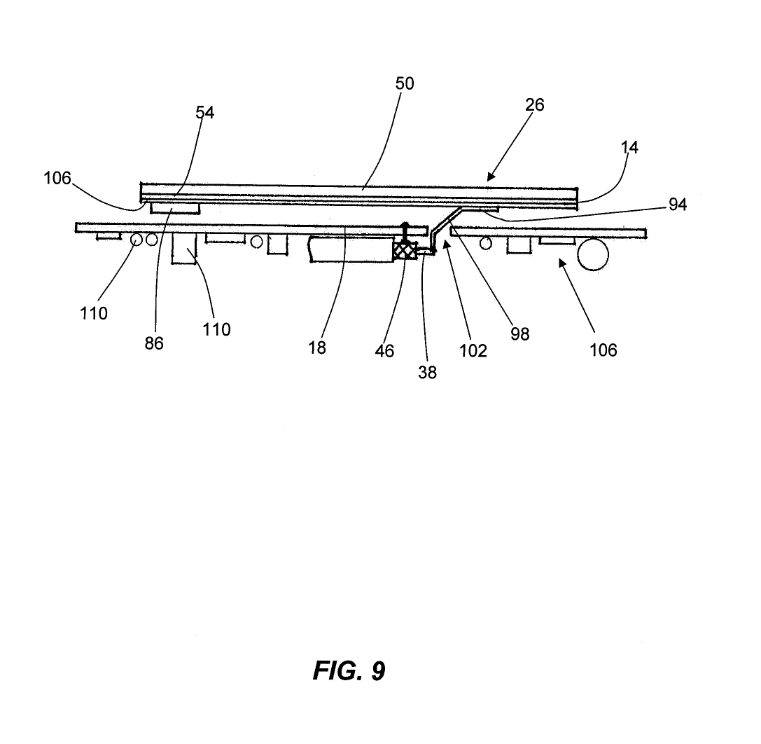

Turning now to FIG. 9, a side view of a patch antenna of the present invention is shown. The patch antenna includes the various aspects and details shown in FIGS. 5-8, and shows additional details of a completed antenna. As discussed, the lower layer 54 of a solar panel 50 is used to form the active element 14 of the patch antenna. A thin metal sheet or foil 106 may be used if necessary to improve the RF conductivity or the coupling of separate plates of the lower layer 54. The active element 14 is parallel to the ground plane 18.

The feed point 26 of the antenna is connected to the signal wire 38. The signal wire may be connected to the active element 14 via a capacitive plate 94 and spring arm 98 as has been discussed. Such a connection allows for easy removal of the solar panel 50 if necessary, as the capacitive plate 94 need not be soldered to the active element 14. Other connection members may be used, such as a soldered wire, spring or post, or a spring or post with a capacitive plate. The signal wire 38 or spring arm 98 may pass through a hole 102 in the ground plane 18.

If desired, a ferrite bar 86 may be used to limit the size of the active element 14. Alternatively, the remaining parameters of the patch antenna such as the feed point location may be adjusted to compensate for the size of the active element 14.

The ground shield 46 of the signal wire is connected to the ground plane 18. The ground layer of a printed circuit board 106 may be used to form the ground plane 18. Such is advantageous as it eliminates the need for a separate ground plane, saving cost and allowing the device to be more compact. It is desirable that the ground layer of the circuit board 106 be relatively continuous. It is believed that if the ground layer has too many holes or gaps that signal quality may begin to diminish. If the ground layer of a circuit board 106 is used as the ground plane 18, it is desirable (but not required) that circuit board is placed so that the electronic components 1 10, such as resistors and capacitors, are not placed between the active element 14 and the ground plane 18. A number of electronic components 110 between the active element 14 and the ground plane 18 may interfere with signal quality, or may alter the dielectric constant of the material between the ground plane and active element.

Analysis has shown that the majority of the high frequency currents from the patch antenna flow on the surface of the active element 14 which faces the ground plane 18 and vice versa. Thus, the operation of the patch antenna should have little effect on the DC current and operation of the solar panel 50 and the operation of the circuit board 106. If the circuit board 106 contains sensitive devices which may be affected by the high frequency signals from the patch antenna, filters may be used to isolate these devices. Alternatively, a ground plane 18 separate from the circuit board 106 may be used.

There is thus disclosed an improved combined solar panel and patch antenna. It will be appreciated that numerous changes may be made to the present invention without departing from the scope of the claims.

What is claimed is:

1. A patch antenna comprising:
an active element formed from a portion of a solar cell; and
a ground plane spaced apart from the active element and parallel with the active element.

2. The patch antenna of claim 1, wherein the active element is formed from the positive terminal of the solar cell.

3. The patch antenna of claim 1, further comprising a conductive layer affixed to the underside of the solar panel to improve the RF response of the solar panel.

4. The patch antenna of claim 1, further comprising a ferrite bar for limiting the size of the solar panel which is effective as the active element.

5. The patch antenna of claim 1, wherein the ground plane is formed by a circuit board.

6. The patch antenna of claim 5, wherein the ground plane is formed by the ground layer of the circuit board.

7. The patch antenna of claim 1, further comprising a signal wire for receiving signals from the active element.

8. The patch antenna of claim 1, wherein the signal wire is not attached to the active element.

9. The patch antenna of claim 1, wherein the signal wire is connected to a capacitive plate placed adjacent to the solar panel.

10. The patch antenna of claim 9, wherein the capacitive plate is held against the active element by a spring.

11. A communication and power device comprising:
a solar cell; and
an antenna, at least a part of the antenna being formed from a portion of the solar cell.

12. The device of claim 11, wherein the positive terminal of the solar cell forms the active element of the patch antenna.

13. The device of claim 12, further comprising a ferrite bar for limiting the size of are of the positive terminal which functions as part of the patch antenna.

14. The device of claim 11, wherein the ground plane of the patch antenna is formed by the ground plane of a circuit board.

15. The device of claim 12, wherein the electrical signal connection to the active element comprises a capacitive plate held against the active element.

16. A combined solar cell and patch antenna comprising:
a solar cell, the solar cell having a generally planar positive terminal;
a patch antenna, the patch antenna comprising a ground plane and an active element disposed parallel to the ground plane and spaced apart therefrom; and
wherein the positive terminal of the solar cell forms the active element of the patch antenna.

17. The combined solar cell and patch antenna of claim 16, wherein the patch antenna further comprises a conductive layer placed adjacent the positive terminal of the solar cell.

18. The combined solar cell and patch antenna of claim 17, wherein the ground plane is formed by a ground layer of a circuit board.

19. The combined solar cell and patch antenna of claim 16, wherein the electrical connection to the active element comprises a planar element held against the active element so as to be capacitively coupled to the active element.

20. The combined solar cell and patch antenna of claim 16, further comprising a ferrite bar disposed against the positive terminal of the solar cell so as to effectively limit the size of the positive terminal which forms the active element of the patch antenna.
